(19) United States
(12) Patent Application Publication
(10) Pub. No.: US 2010/0082145 A1
(43) Pub. Date: Apr. 1, 2010

(54) ROUTING MANAGER

(75) Inventors: N. Andrew Weatherhead, Ayr (CA); Raymond John Staron, Chagrin Falls, OH (US); John R. Parraga, Anthem, AZ (US); Mark K. Carmount, Ayr (CA); Philip J. Kaufman, Milwaukee, WI (US)

Correspondence Address: ROCKWELL AUTOMATION;for Turocy & Watson LLP, 1201 SOUTH SECOND STREET, E-7F19, MILWAUKEE, WI, 53204, US

(73) Assignee: Rockwell Automation Technologies, Inc., Mayfield Heights, OH (US)

(21) Appl. No.: 12/368,202

(22) Filed: Feb. 9, 2009

Related U.S. Application Data
(60) Provisional application No. 61/101,238, filed on Sep. 30, 2008.

(51) Int. Cl. G06F 17/00; G06F 7/00

(52) U.S. Cl. 700/106; 700/228; 715/771

(57) ABSTRACT

The invention relates to systems and/or methodologies for route management. More particularly, the invention relates to an industrial controller (e.g., logic controller) based route management solution. The route management solution can statically and/or dynamically determine, maintain, or otherwise manage a route.

### CROSS-REFERENCE TO RELATED APPLICATIONS

This application claims priority to U.S. Provisional Application Ser. No. 61/101,238, filed Sep. 30, 2008, entitled “ROUTING MANAGER”, the entirety of which is incorporated herein by reference.

### TECHNICAL FIELD

The subject innovation relates generally to industrial automation design, and more particularly to industrial controller based systems and/or methodologies for defining and/or implementing one or more routes from a source to a destination.

### BACKGROUND

Industrial controllers are special-purpose computers utilized for controlling industrial processes, manufacturing equipment, and other factory automation, such as data collection or networked systems. At the core of the industrial control system, is a logic processor such as a Programmable Logic Controller (PLC) or PC-based controller. Programmable Logic Controllers for instance, are programmed by systems designers to operate manufacturing processes via user-designed logic programs or user programs. The user programs are stored in memory and generally executed by the PLC in a sequential manner although instruction jumping, looping and interrupt routines, for example, are also common. Associated with the user program are a plurality of memory elements or variables that provide dynamics to PLC operations and programs. Differences in PLCs are typically dependent on the number of Input/Output (I/O) they can process, amount of memory, number and type of instructions, and speed of the PLC central processing unit (CPU).

One area that has Seen significant growth in recent years is route management in industrial applications. Route management includes the movement of materials from a set of source storage containers through a limited set of intermediary containers (e.g., pipes, conveyers) to a set of destination containers or equipment (fillers). Typically, route management is accomplished by hard coding or manual entering of all possible combinations and permutations of routes into a controlling software along with a human machine interface.

Hard coding and manually entering all possible combinations and permutations of routes into a controlling software can be extremely inefficient. For example, troubleshooting or upgrading equipment can often require massive amounts of re-engineering. Therefore, it would be desirable to have an efficient and convenient routing management solution.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

The claimed subject matter relates to a system and/or method for convenient and efficient programmable logic controller based route determinations. In accordance with various aspects of the claimed subject matter an industrial controller controls at least one device within a set of paths and/or obtains data from at least one device within a set of paths, and a routing component that determines at least one route from a destination to a source within the paths.

In additional aspects, a method facilitating routing management is disclosed, the method includes storing a set of routing data in a memory, wherein the routing data defines one or more routes from a source to a destination, translating the routing data into a set of industrial controller executable commands, and implementing the route by controlling at least one device along the route via the industrial controller.

In still other aspects, a routing management method is disclosed, that includes a programmable controller that executes the steps of: determining at least one source for at least one ingredient in a product, and at least one destination for at least one of a bi-product of manufacture based on the ingredients, or the ingredients, and calculating at least one route from the source to the destination.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 is an example general component block diagram illustrating a system facilitating routing management in accordance with an aspect of the present specification.

FIG. 2 is an example general component block diagram of a routing component shown in accordance with an aspect of the present specification.

FIG. 3 is an example diagram illustrating a plurality of routes within a given path in accordance with an aspect of the present specification.

FIG. 4 is an example illustration of a routing diagram in accordance with an aspect of the present specification.

FIG. 5 illustrates an example material compatibility chart in accordance with an aspect of the present specification.

FIG. 6 is an example flow chart illustrating a generalized methodology of static routing management in accordance with an aspect of the present specification.

FIG. 7 illustrates an example methodology facilitating dynamic route management in accordance with an aspect of the present specification.

FIG. 8 illustrates an example methodology for routing management in accordance with an aspect of the present specification.

FIG. 9 is a perspective view illustrating an example industrial controller having multiple functional modules contained in several racks joined by communication links in accordance with an aspect of the present specification.

FIG. 10 is a schematic block diagram of an example single functional module of illustrating the connection to a common backplane and communication links to communicate with other modules in accordance with an aspect of the present specification.

FIG. 11 illustrates a system that employs an artificial intelligence component which facilitates automating one or more features in accordance with the subject specification.

FIG. 12 is a schematic block diagram of a sample-computing environment with which the subject specification can interact.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are illustrated in block diagram form in order to facilitate describing the embodiments.

As used in this application, the terms “component,” “system,” “object,” “model,” “policy,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Furthermore, inference can be based upon logical models or rules, whereby relationships between components or data are determined by an analysis of the data and drawing conclusions therefrom. For instance, by observing that one user interacts with a subset of other users over a network, it may be determined or inferred that this subset of users belongs to a desired social network of interest for the one user as opposed to a plurality of other users who are never or rarely interacted with.

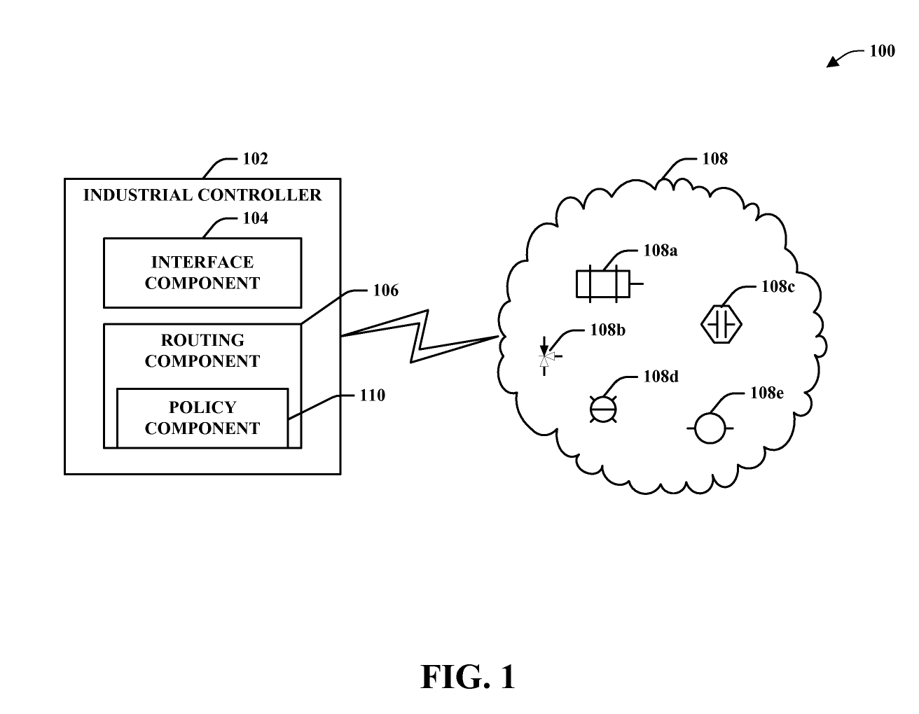

Referring initially to FIG. 1, an example system 100 facilitating routing management is shown in accordance with an aspect of the present innovation. The system 100 includes an industrial controller 102 (discussed infra) having an interface component 104 and a routing component 106. The interface component 104 includes any suitable and/or necessary adapters, connectors, channels, communication paths, etc. to integrate the system 100 into virtually any operating and/or database system(s). For example, the interface component 104 can enable the industrial controller 102 to acquire data from an external source, such as a mobile device (e.g. laptop, smart phone, PDA, etc.), a computer, a touch screen, a controller, and so forth.

In addition, the interface component 104 enables the industrial controller 102 to communicate with one or more devices 108. The devices 108 can include most any of a plurality of industrial control devices, including but not limited a motor 108a, a valve 108b, a sensor 108c, an indicator 108d, a pump 108e, and so forth. In operation, the industrial controller 102 can communicate instructions to one or more of the devices 108 and/or obtain data, measurements, or information from the devices 108. For instance, the devices 108 can include a temperature sensor, wherein the industrial controller 102 can obtain a current/voltage signal that corresponds to a temperature measurement from the temperature sensor.

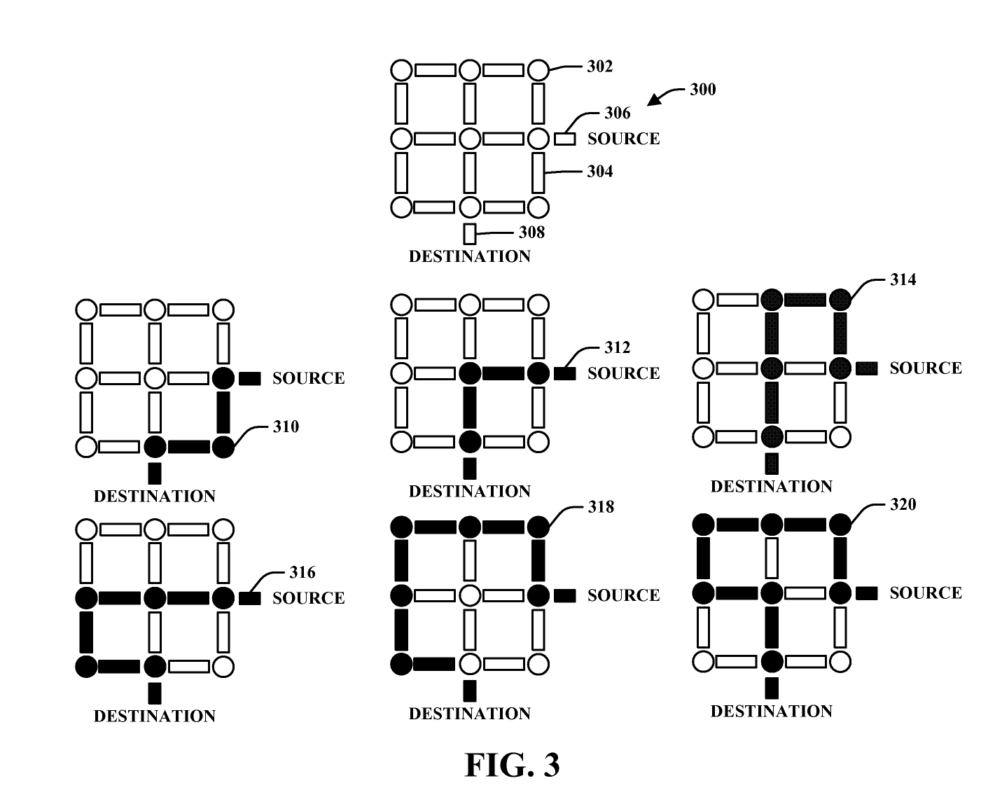

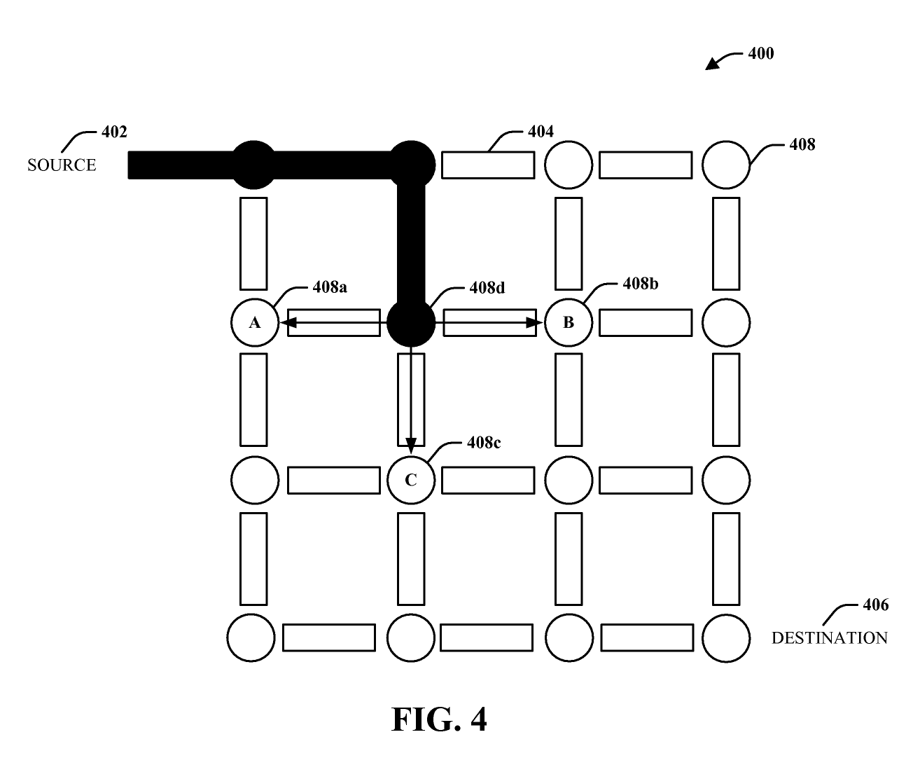

The routing component 106 provides for an industrial controller 102 based solution enabling static and/or dynamic routing from one or more sources to one or more destinations. The routing component 106 enables static routing by interpreting data (e.g. a table) that defines a specific route from a source to a destination. The route can be defined as one or more means of conveying (e.g. conduit, channel, conveyor, pipes, etc.) one or more materials (e.g. liquid, gas, solids, etc.) from a starting point to a target location (See FIGS. 3 and 4). Additionally or alternatively, the routing component 106 can determine one or more routes, from the source to the destination, based on the real-time monitoring of the devices 108. The routing component 106 can determine a route from a list of 1 to n routes, wherein n is an integer. A user can manually select the route to be used, or the routing component 106 can automatically determine the route. For simplicity of explanation, the industrial controller 102 is shown as having a single routing component 106; however it is to be appreciated that the industrial controller 102 can include a plurality of routing components 106.

The routing component 106 supports multiple states, including but not limited to starting, running, stopping, holding, restarting, aborting, and so forth. For each state, the routing component 106 can enable a separate sequence of devices 108. The state sequence can allow inclusion of most any device 108 assigned to a route. Additionally or alternatively, devices 108 which are not included within a particular state can remain in their existing state. For instance, the routing component 106 can have the ability to close select valves in the holding state.

The routing component 106 can support multiple steps within a given state, wherein the steps enable the routing component 106 to sequence devices. On each step one or many devices 108 may be sequenced. For example, a routing component 106 interface can include: Abort command, Aborted Status; Hold Command, Held Status; Starting Status; Restart Command, Restarting Status. In addition, the routing component 106 can enable monitoring the state of most any devices 108 which are not controlled within a given route. Moreover, the routing component 106 enables configuration of devices 108 to pulse, and the ability to assign one or more pulse sequences, and number of pulses for each device 108, and the ability to loop the sequences for a predefined number of loops. For example, the routing component 106 can monitor a number of times the sequences have been completed.

The routing component 106 can include a policy component 110. The policy component 110 can contain one or more policies, wherein the routing component 106 can determine the route(s) based at least in part on the policies. For instance, the policies can include one or more business rules that affect the possible routes. Consequently, the routing component 106 will determine one or more routes that follow or do not violate the business rules. Additionally or alternatively, the policies component 110 can contain one or more sets of material compatibility rules. The material compatibility rules can be used by the routing component 106 to determine one or more possible routes as well (discussed infra).

The policy component 110 can obtain the policies from most any of a plurality of sources. For instance, the policies can be acquired via the interface component 104 from a data store (not shown), an external source, user input, and so forth. It is to be appreciated that this is but one example, and multiple embodiments are possible within the scope and spirit of the subject innovation.

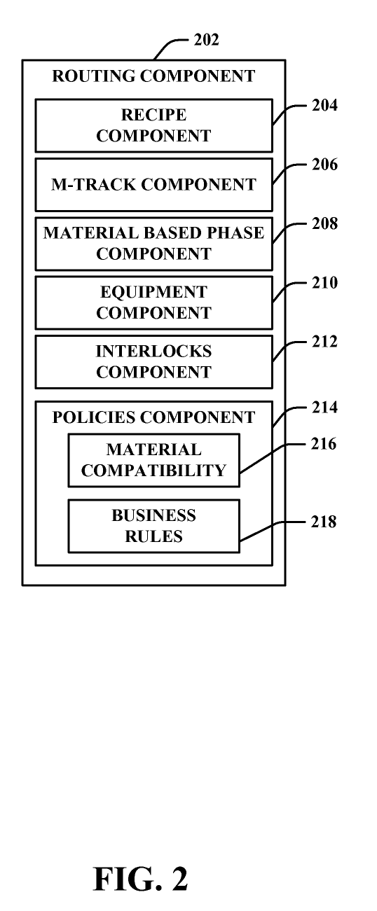

Turning to FIG. 2, an example general component block diagram of a routing component 202 is shown in accordance with an aspect of the current innovation. As discussed previously, the routing component 202 provides for an industrial controller based solution enabling static and/or dynamic routing from one or more sources to one or more destinations. The routing component 202 can determine one or more routes, from the source to the destination, based at least in part on the real-time monitoring of a set of devices associated with the route, a set of material compatibility, and/or a set of business rules. The routing component 202 can determine a route from a list of 1 to n routes, wherein n is an integer. Ultimately, the route used can be selected by a user from one or more suggested routes, or the routing component 202 can automatically determine the route used. Additionally or alternatively, the routing component 202 enables static routing by interpreting data (e.g. a routing table) that defines a specific route from a source to a destination. The route can be defined as one or more means of conveying (e.g. conduit, channel, conveyor, pipes, etc.) one or more materials (e.g. liquid, gas, solids, etc.) from a starting point to a target location (See FIGS. 3 and 4).

The routing component 202 includes a recipe component 204, a material track (m-track) component 206, a material based phase component 208, an equipment component 210, an interlocks component 212, and a policies component 214. The recipe component 204 can receive, acquire, or otherwise obtain one or more recipes. The recipes define a set of products to be delivered. For example, the recipe component 204 can obtain a recipe for a product Z, wherein the recipe for Z contains 0.25 of an ingredient W, 0.25 of an ingredient X, and 0.5 of an ingredient Y.

The material track component 206 determines one or more sources to use for the recipe based on a set of container priorities. The container priorities maintain a priority level for one or more containers. Returning to the previous example, there can be a plurality of containers having the ingredient W. The priority levels maintained in the container priorities can determine the order in which the containers should be used as a source for the ingredient W. The material based phase component 208 determines one or more routes required to implement the recipe using the container priorities. Again reverting to the previous example, in order to manufacture the product Z using the ingredients W, X, and Y several steps may be involved. The material based phase component 208 can determine routes possible for the steps. For instance, manufacturing the product Z can require a first step of heating the ingredient W and a second step of cooling the ingredient W. The material based phase component 208 can determine the routes that incorporate a heater for the first step, and a refrigerator for the second step. It is to be appreciated that this is but one example, and a plurality of routes and steps are possible within the scope and spirit of the subject innovation.

The equipment component 210 can determine one or more pieces of equipment to be used, and request control of the equipment. Staying with the previous example, the equipment component 210 determines that the heater and refrigerator are associated with the route, and requests control of the heater and refrigerator for use by the routing component 202. The interlocks component 212 can determine undesired states for the equipment associated with route, and implement one or more instructions that prevent the equipment from entering the undesired state(s). For example, the interlocks component 212 can determine the undesirable states based at least in part on a set of material compatibility rules and/or business rules (discussed infra), and implement a set of instructions to prevent the equipment from entering a state that conflicts with the material compatibility and/or business rules.

As previously discussed, the policies component 214 can contain one or more policies, that can impact, influence, or otherwise affect the routes determined by the routing component 202. The policies component 214 includes a set of material compatibility rules 216 and a set of business rules 218. The material compatibility rules 216 contain regulations regarding the ability to mix, blend, or otherwise combine two or more materials. For example, the material compatibility rules 216 can state that the ingredient W and the ingredient Y may not be able to mix until a final stage of production. Consequently, W may not be able to traverse any conduits that have previously been traversed by Y and/or vice/versa. As an additional example, the business rules 218 can contain a set of rules regarding the quality of the ingredient Y to be used in the manufacture of the product Z, which impacts the container priorities determined by the M-track component 206. It is to be appreciated that the routing component 202 is illustrated for simplicity and brevity of explanation; however a plurality of possible embodiments of routing components are possible within the scope and spirit of the subject innovation.

FIG. 3 is an example diagram illustrating a plurality of routes within a given path in accordance with an aspect of the present innovation. It is to be appreciated that the terms path and route can be used interchangeably; however for simplicity of explanation for the purposes of describing this illustration only, the term path refers to the set of most all conduits that could be used in a route from a source to a destination, and route refers to a subset of the conduits connecting the source to the destination. For example, a city map could be an illustration of a path, and the streets used to get from a starting point to a target destination could be the route.

The example path 300 is illustrated as a three by three matrix having nine matrix valves 302 and twelve channels 304. The path has a source 306 and a destination 308. For example, the source 306 and the destination 308 can be determined by a routing component based on a recipe and/or routing instructions (discussed supra). It can be Seen that a plurality of routes are possible using various combinations of matrix valves 302 and channels 304 from the source 306 to the destination 308. Without traversing any of the matrix valves 302 or channels 304 more than once there are six possible routes 310-320 from the source 306 to the destination 308.

As discussed previously, the industrial controller based routing component can dynamically determine the routes within the path 300 based at least in part on a set of business rules, a set of material compatibility rules, and/or real-time monitoring of devices such as the matrix valves 302 and channels 304. For example, if the matrix valve in the bottom right corner of the path 300 is inoperable then the route 310 will not be used by the routing component. Additionally or alternatively, the routing component can determine that each of the routes 310-320 is possible and a user may select their preferred route. It is to be appreciated that this is but one example illustrated for simplicity of explanation and brevity, and that most any number and type of devices, channels, valves, and so forth can comprise a path within the scope and spirit of the subject innovation.

FIG. 4 is an example illustration or a routing diagram 400 having multiple paths in accordance with an aspect of the present innovation. In this example, the paths are comprised of a series of conduits 404 for conveying a material from a source 402 to a target destination 406. The conduits 404 can be connected by one or more multi-directional valves 408. A plurality of routes from the source 402 to the destination 406 can be determined by closing or opening one or more valves 408 (See FIG. 3). For instance, the material is shown as being currently located at the valve 408d. From this position three routes are available a first route toward 408a, a second route toward 408b, or a third route toward 408c, and from each of those valves one or more possible routes can be determined by opening or closing the corresponding valve. In this way, a plurality of routes from the source 402 to the target destination 406 can be achieved along the paths 400.

As previously discussed, each possible route is not necessarily reflective of a best or even a practical route. A number of routes can be eliminated based on one or more policies. For instance, continuing with the example discussed supra, the conduit 404 leading to the valve 408a may not be useable based on one or more material compatibility rules. In addition, the conduit 404 may not be practical based on one or more business rules. Moreover, the conduit 404 leading to the valve 408c may not be operable due to a failure. Therefore, the best possible route from the valve 408d to the destination 406 may involve using the conduit 404 leading to the valve 408b.

It is to be appreciated that it would be desirable to have a controller based system and/or methodology that can determine one or more routes through the paths 400, while accounting for a set of policies and/or real time monitoring of the devices located along or in the paths 400.

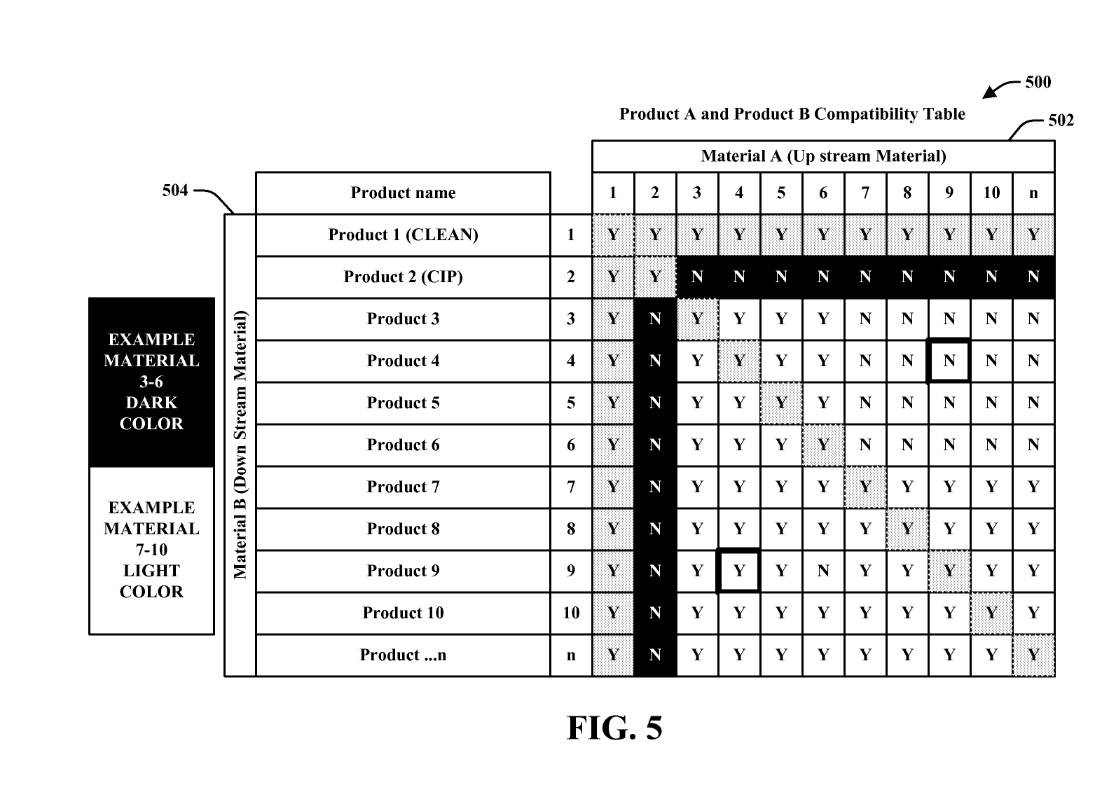

FIG. 5 is illustrative of an example material compatibility table in accordance with an aspect of the subject innovation. The table 500 illustrates the compatibility rules for a set of materials across a valve. More particularly, the table illustrates the compatibility between an upstream material A 502 (e.g., columns) that can flow into a downstream material B 504 (e.g., rows).

The table is illustrated as having 1-n downstream materials 504 and upstream materials 502, where n is an integer. The first example material (e.g., product 1) represents a clean pipe, and the second example material (e.g., product 2) represents one or more clean in-place (CIP) cleaning solutions. The third through the sixth materials (e.g., product 3-6) are dark materials and the seventh through the tenth materials (e.g., product 7-10) are light materials.

The two dimensional array illustrated in the table 500 contains editable fields that define if the materials are compatible (e.g., Y) or not compatible (e.g., N). For example, the table as illustrated shows that all the materials (products 2-n) can flow into a clean pipe (e.g., row 1). However, none of the materials are allowed to flow into the cleaning solutions (e.g., row 2). In addition, the dark materials can flow into a light material, but light materials cannot flow into a dark material, as illustrated by row 4 column 9, and row 9 column 4.

As previously discussed, a routing component (See FIGS. 1 and 2) can contain, translate, or otherwise determine one or more material compatibility rules. The material compatibility rules can be based at least in part on the materials being moved, a state of most all valves in the system, a history of what materials were last moved, the last cleaning of each valve/conduit, and so forth. It is to be appreciated that this is but one example of a material compatibility table, and a plurality of techniques for defining material compatibility are possible within the scope and spirit of the subject innovation, including a material compatibility table having greater than two dimensions, a database, a set of computer instructions, and so forth.

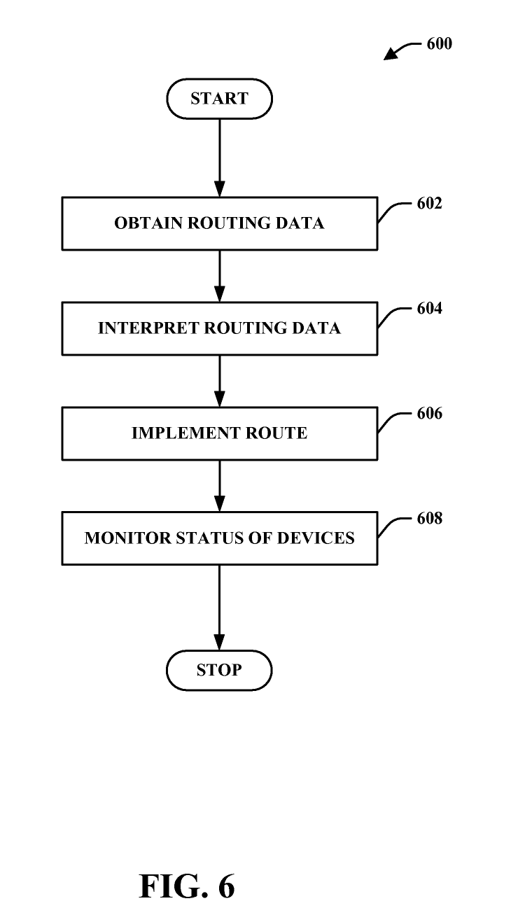

In view of the example systems described supra, methodologies that may be implemented in accordance with the disclosed subject matter will be better appreciated with reference to the flow charts of FIGS. 6-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

With reference to FIG. 6, an example flow chart illustrating a generalized methodology of static routing management in accordance with an aspect of the present specification. At 602, a set of routing data is obtained. The routing data can be most any form, including but not limited to a routing table, a routing diagram, a database, a set of computer executable commands, and so forth. The routing data defines a specific route from a source to a destination.

At 604, the routing data is interpreted, converted, or otherwise translated into a set of instructions that can be used to direct one or more articles along the specified route. For instance, a series of valves may need to be controlled in order to implement the specified route, and the routing data can be translated into a set of instructions effective to control the necessary valves. At 606, the route contained in the routing table is implemented by controlling the necessary devices using the set of instructions interpreted from the routing table.

At 608, the statuses of the devices within the defined path are monitored in real-time. The devices can be monitored to confirm information, such as a state (e.g. open/close, on/off, etc.), a mode (auto, manual, etc.), a health indicator (in alarm, out of alarm, in service, not in service, etc.), a material compatibility (e.g. do the business rules allow mixing of two or more materials?), and so forth. The status of the devices can be returned to a user via an indicator (display, etc.), or the route can be altered based on the device status.

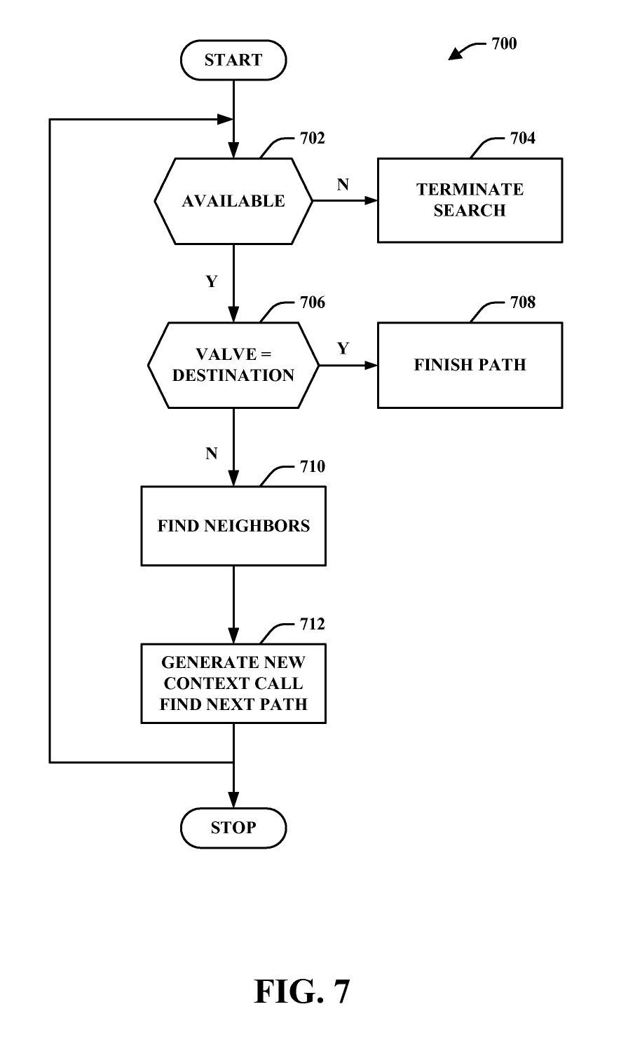

FIG. 7 illustrates an example methodology facilitating dynamic route management in accordance with an aspect of the subject innovation. At 702, a determination is made as to whether a route to the target destination is available. At 704, if there is not an available route to the destination the search is terminated. One or more routes to the destination can be unavailable for a plurality of reasons. For instance, a possible route to the destination may not physically exist, the route can be obstructed by a fault, or the route may be unavailable based on a set of material compatibility rules and/or business policies.

At 706, a determination is made as to whether the current valve is the destination. It is to be appreciated, that most any of a plurality of industrial devices can be the destination, including but not limited to a motor, a valve, a pump, a relay, an indicator, and so forth. At 708, if the valve is the destination, then the path is completed. At 710, if the valve is not the destination, then the current device's neighbors are located.

At 712, once the neighbors are located a new context call can be generated, and the method returns to 702 to find the next path. It is to be appreciated that this is but one example of a methodology facilitating dynamic routing, and a plurality of methods are possible within the scope and spirit of the subject innovation. In addition, it is to be appreciated that the aforementioned methodology for dynamic routing can be used in conjunction with the methodology presented in FIG. 6 for static routing.

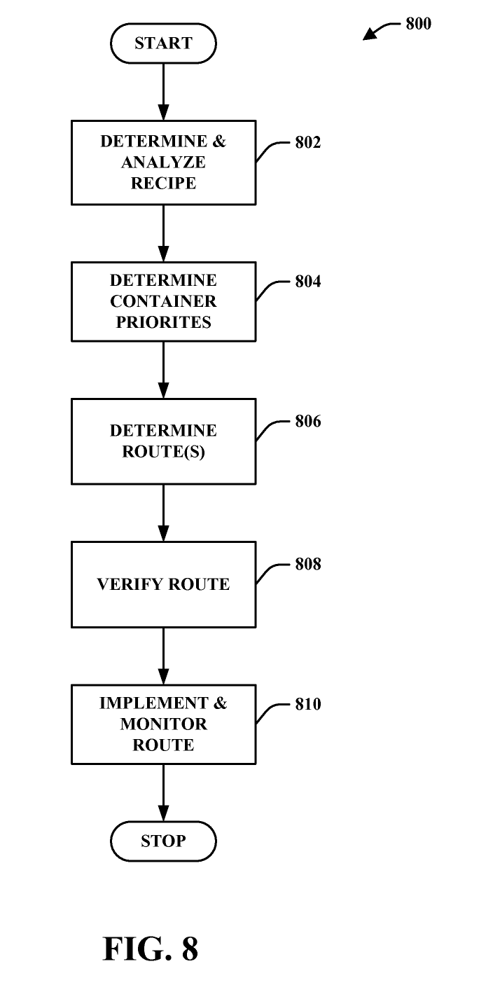

Referring to FIG. 8, an example methodology for routing management is illustrated in accordance with an aspect of the current innovation. At 802, one or more recipes can be received, obtained, or otherwise determined. The recipes can be obtained via explicit user input, acquired from a data store, determined based on a product, and so forth. The recipes indicate a product that needs to be delivered (discussed supra). In addition, the recipes can be analyzed. For example, a recipe for a product A can include the ingredients B, C, and D.

At 804, one or more container priorities can be determined for the ingredients contained in the recipes. The container priorities specify a source for the ingredients. As discussed supra, the ingredients can have a plurality of possible sources, and the container priorities can detail the order in which those sources are to be used. At 806, one or more routes can be determined (See FIG. 7). The routes are determined based at least in part on the source indicated in the container priorities, and the destination required to implement the recipe, a set of business rules, and/or a set of material compatibility rules. At 808, the route is verified. The route can be verified by explicit user input or verification can be based on a set of business rules. Additionally or alternatively, verification of the route can be based on artificial intelligence (discussed infra).

At 810, the route is implemented. Implementation of the route can involve acquiring control of devices associated with the route, and controlling the devices. For example, a series of valves along the route can be required for implementation of the route. In addition, the route devices associated with the route are monitored in real-time for a plurality of factors, such as health. The route can be automatically updated or indications can be displayed, sent, or otherwise communicated to a user. It is to be appreciated that this is but one example, and a plurality of route management techniques are possible within the scope and spirit of the subject innovation.

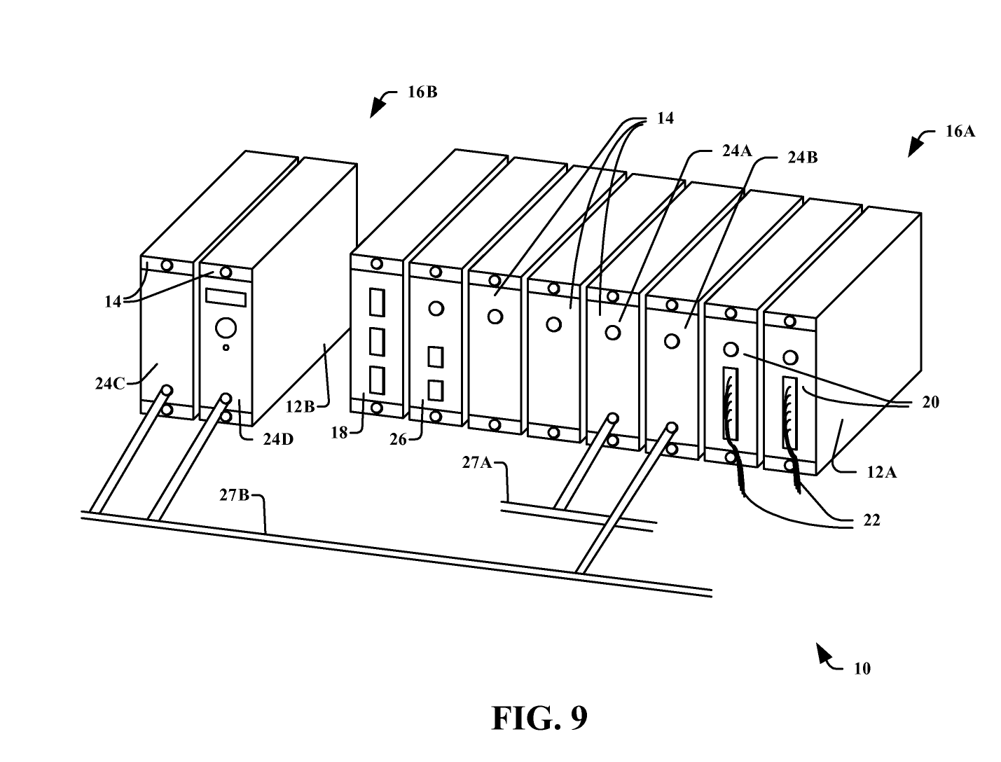

Referring to FIG. 9, a distributed industrial control system 10 suitable for use with the present invention provides a first and second rack 12A and 12B for holding a number of functional modules 14 electrically interconnected by backplanes 16A and 16B running along the rear of the racks 12A and 12B respectively. Each module 14 may be individually removed from the rack 12A or 12B thereby disconnecting it from its respective backplane 16 as will be described below for repair or replacement and to allow custom configuration of the distributed system 10.

The modules 14 within the rack 12A may include, for example, a power supply module 18, a processor module 26, two communication modules 24A and 24B and two I/O modules 20. A power supply module 18 receives an external source of power (not shown) and provides regulated voltages to the other modules 14 by means of conductors on the backplane 16A.

The I/O modules 20 provide an interface between inputs from, and outputs to external equipment (not shown) via cabling 22 attached to the I/O modules 20 at terminals on their front panels. The I/O modules 20 convert input signals on the cables 22 into digital words for transmission on the backplane 16A. The I/O modules 20 also convert other digital words from the backplane 16A to the necessary signal levels for control of equipment.

The communication modules 24A and 24B provide a similar interface between the backplane 16A and one of two external high speed communication networks 27A and 27B. The high speed communication networks 27A and 27B may connect with other modules 14 or with remote racks of I/O modules 20 or the like. In the example illustrated, the high speed communication network 27A connects with backplane 16A via the communication module 24A, whereas the high speed communication network 27B connects the communication module 24B with communication modules 24C and 24D in rack 12B.

The processor module 26 processes information provided by the communication modules 24A and 24B and the I/O modules 20 according to a stored program and provides output information to the communication module 24 and the I/O modules 20 in response to that stored program and received input messages.

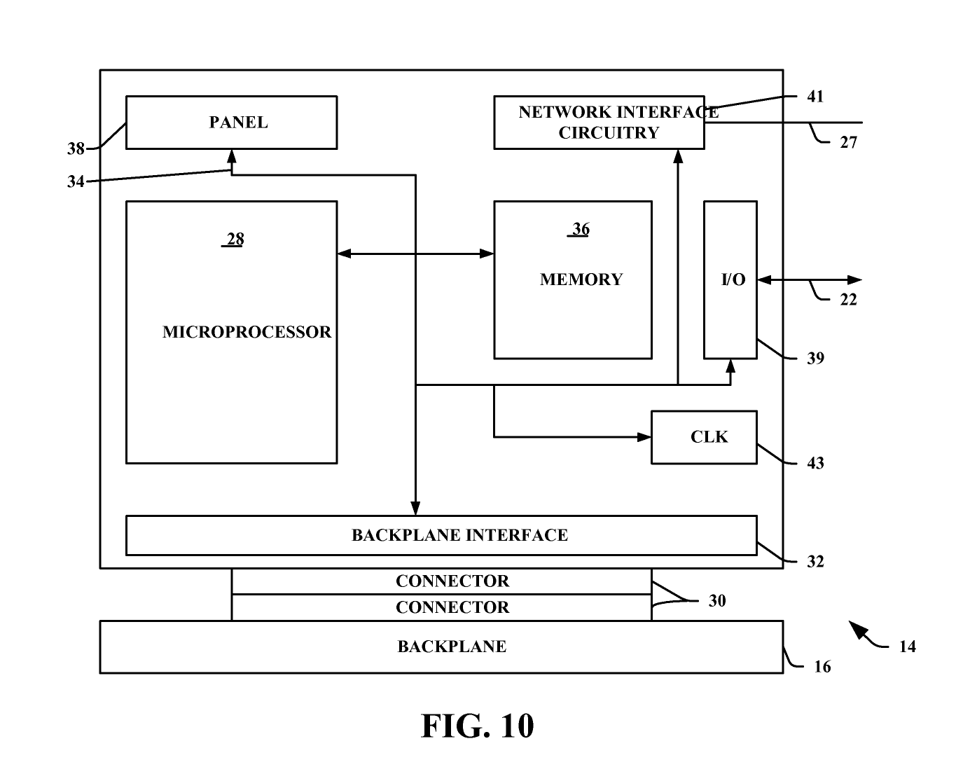

Referring also to FIG. 10, each functional module 14, is attached to the backplane 16 by means of a separable electrical connector 30 that permits the removal of the module 14 from the backplane 16 so that it may be replaced or repaired without disturbing the other modules 14. The backplane 16 provides the module 14 with both power and a communication channel to the other modules 14.

Local communication with the other modules 14 through the backplane 16 is accomplished by means of a backplane interface 32 which electrically connects the backplane 16 through connector 30. The backplane interface 32 monitors messages on the backplane 16 to identify those messages intended for the particular module 14, based on a message address being part of the message and indicating the message's destination. Messages received by the backplane interface 32 are conveyed to an internal bus 34 in the module 14.

The internal bus 34 joins the backplane interface 32 with a memory 36, a microprocessor 28, front panel circuitry 38, I/O interface circuitry 39 (if the module is an I/O module 20) and communication network interface circuitry 41 (if the module is a communication module 24). The microprocessor 28 may be a general purpose microprocessor providing for the sequential execution of instructions contained in memory 36 and the reading and writing of data to and from the memory 36 and the other devices associated with the internal bus 34.

The microprocessor 28 includes an internal clock circuit (not shown) providing the timing of the microprocessor 28 but may also communicate with an external precision clock 43 of improved precision. This clock 43 may be a crystal controlled oscillator or other time standard including a radio link to an NBS time standard. The precision of the clock 43 is recorded in the memory 36 as a quality factor. The panel circuitry 38 includes status indication lights such as are well known in the art and manually operable switches such as for locking the module 14 in the off state.

The memory 36 holds programs executed by the microprocessor 28 to provide the functions as will be described and also variables and data necessary for the execution of those programs. For I/O modules 20, the memory 36 also includes an I/O table holding the current state of inputs and outputs received from and transmitted to the industrial controller 10 via the I/O modules 20.

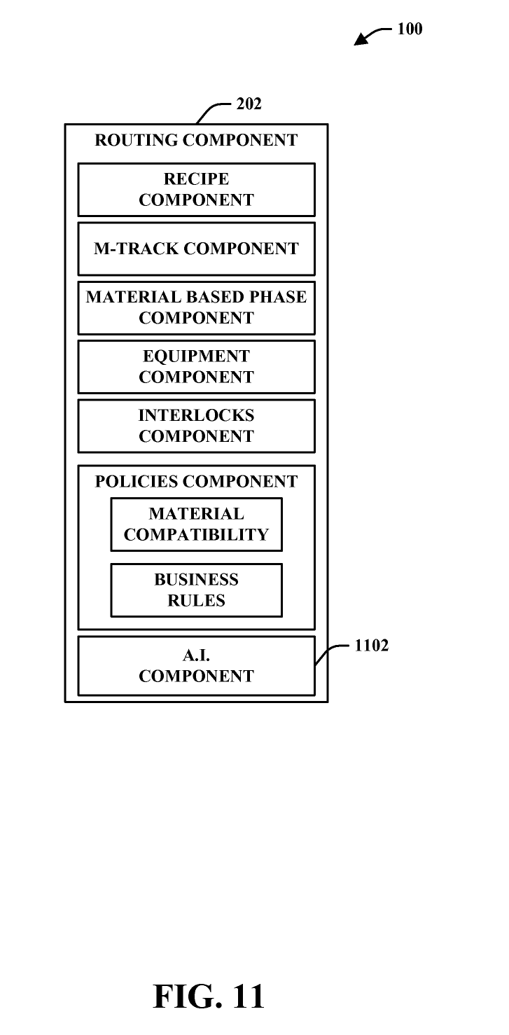

FIG. 11 illustrates a system 1100 that employs an artificial intelligence (AI) component 1102 which facilitates automating one or more features in accordance with the subject innovation. The subject innovation (e.g., in connection with inferring) can employ various AI-based schemes for carrying out various aspects thereof. For example, a process for dynamic routing management can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to update or refine the previously inferred schema, tighten the criteria on the inferring algorithm based upon the kind of data being processed (e.g., financial versus non-financial, personal versus non-personal, . . . ), and at what time of day to implement tighter criteria controls (e.g., in the evening when system performance would be less impacted).

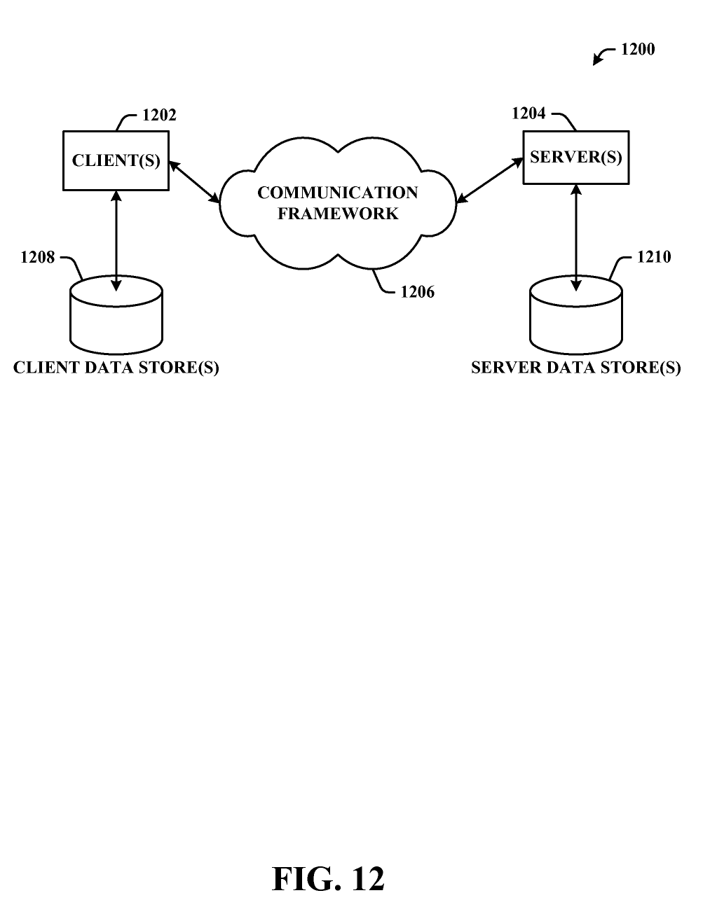

Referring now to FIG. 12, there is illustrated a schematic block diagram of an example computing environment 1200 in accordance with the subject innovation. The system 1200 includes one or more client(s) 1202. The client(s) 1202 can be hardware and/or software (e.g., threads, processes, computing devices). The client(s) 1202 can house cookie(s) and/or associated contextual information by employing the innovation, for example.

The system 1200 also includes one or more server(s) 1204. The server(s) 1204 can also be hardware and/or software (e.g., threads, processes, computing devices). The servers 1204 can house threads to perform transformations by employing the innovation, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A routing management system, comprising:
an industrial controller that at least one of: controls at least one device within a set of paths, or obtains data from at least one device within a set of paths, and includes a routing component that determines at least one route from at least one destination to at least one source within the paths.

2. The system of claim 1, the routing component at least one of infers or determines at least one of the source or destination based at least in part on at least one recipe.

3. The system of claim 1, the routing component determines at least one source based at least in part on at least one container priority.

4. The system of claim 1, the routing component determines the routes based at least in part on data obtained from at least one data source.

5. The system of claim 4, the data sources include at least one table, diagram, drawing, or specification that defines at least one route from the source to the destination.

6. The system of claim 1, the routing component determines the route via explicit user input.

7. The system of claim 1, the routing component dynamically determines the routes based at least in part on data obtained by the industrial controller from one or more devices.

8. The system of claim 7, the routing component further determines the routes based at least in part on at least one of a set of business rules, or a set of material compatibility rules.

9. The system of claim 1, the routing component dynamically modifies the route based at least in part on at least one of data obtained from the devices by the industrial controller, a set of material compatibility rules, or a set of business rules.

10. The system of claim 1, the routing component implements the route by controlling at least one device located in the route via the industrial controller.

11. The system of claim 1, further comprising an artificial intelligence component that facilitates automating one or more aspects of the system.

12. A method facilitating routing management, comprising:
storing a set of routing data in a memory, wherein the routing data defines one or more routes from a source to a destination;
translating the routing data into a set of industrial controller executable commands; and
implementing the route by controlling at least one device along the route via the industrial controller.

13. The method of claim 12, further comprising monitoring the statuses of the devices.

14. The method of claim 13, further comprising dynamically updating the route based at least in part on at least one of: a status of at least one device, a set of business rules, or a set of material compatibility rules.

15. The method of claim 12, wherein the routing data includes at least one of a routing table, a diagram, a specification, or a set of computer executable commands.

16. A routing management method, comprising:
a programmable controller that executes the following steps:
determining at least one source for at least one ingredient in a product, and at least one destination for at least one of a byproduct of manufacture based on the ingredients, or the ingredients; and
calculating at least one route from the source to the destination.

17. The method of claim 16, further comprising calculating the routes based at least in part on a set of policies.

18. The method of claim 17, wherein the policies include at least one of a set of business rules or a set of material compatibility rules.

19. The method of claim 16, further comprising determining at least one of the sources based at least in part on at least one container priority.

20. The method of claim 16, further comprising determining at least one of at least one of the sources or at least one of the destinations based at least in part on at least one recipe.

21. The method of claim 16, further comprising recalculating the route based at least in part on a current characteristic of at least one device in the route.

22. A route determination method, comprising:
identifying at least one available route from a first node to a second node in a given path, and terminating the route determination if a route to a second node is not available; and
determining if the second node is the destination, and completing the route if the second node is the destination.

23. The method of claim 22, further comprising determining an available route based at least in part on at least one of a set of material compatibility rules, a set of business rules, or a real-time monitoring of one or more devices.

24. The method of claim 22, further comprising implementing the route by at least of controlling at least one actuator, or obtaining data from at least one sensor.

25. The method of claim 22, wherein the nodes are at least one of a sensor or an actuator.

26. The system of claim 1, wherein the devices include at least one of a sensor or actuator.

27. A routing system, comprising:
a recipe component that obtains a recipe for at least one product, wherein the recipe includes at least one of a set of ingredients, or a set of steps for manufacture of the product;
a material track component that determines at least one source for each of the ingredients based on a set of container priorities;
a material based phase component that determines at least one route to implement the recipe, wherein a route is at least one of a series of conduits from the sources to a destination, or a set of steps necessary for manufacture of the product using the ingredients;
an equipment component that determines one or more pieces of equipment to be used in the manufacture of the product; and
an interlocks component that analyzes states of the equipment used along the route, and implements at least one instruction to prevent the equipment from entering undesired states.

28. The system of claim 27, wherein the container priorities are priority levels used by the material track component to determine the order in which containers should be used as sources for the ingredients.

29. The system of claim 27, wherein the equipment component request control of the equipment for the routing system.

30. The system of claim 27, further comprising a policies component that maintains a set of policies, wherein the routing system determines routes based at least in part on the policies.

31. The system of claim 30, wherein the set of policies includes a set of material compatibility policies that define the ability to at least one of mix, navigate through common conduits, or combine two or more of the materials.

32. The system of claim 31, wherein the materials include at least one of the ingredients, or cleaning solutions.

33. The system of claim 27, wherein the set of policies includes a set of business rules.

34. The system of claim 33, wherein the business rules define at least one of quality metrics, or available routes for products.

35. The system of claim 27, further comprising a programmable controller that at least one of executes or maintains at least one of the recipe component, the material track component, the material based phase component, the equipment component, and the interlocks component.
